(19) United States
(12) Patent Application Publication
(10) Pub. No.: US 2026/0070438 A1
(43) Pub. Date: Mar. 12, 2026

(54) Locking Device for the Charging Plug of an Electric Vehicle Charging System

(71) Applicant: Wing Kwong, Burnaby (CA)

(72) Inventor: Wing Kwong, Burnaby (CA)

(21) Appl. No.: 18/827,887

(22) Filed: Sep. 9, 2024

(51) Int. Cl. B60L 53/16; H01R 13/639

(52) U.S. Cl. CPC B60L 53/16; H01R 13/6397

(57) ABSTRACT

A locking device for an electric vehicle charging plug using the J1772 standards. The main component of the device consists of an outer shell and an inner shell. In the open position, the inner shell will slide along the designated tracks away from the outer shell, allowing the electrical plug to be insert into the inner shell. In the close position, the outer shell enclosure is moved over the locking hook and prevents plug from being removed from the inner shell. The inner shell has a lock anchor that passes through the outer shell. A user can then install a pad lock at the end through this anchor to prevent the outer shell from sliding back into the open position. The reversal of the above process allows the plug to be removed.

### BACKGROUND OF INVENTION

Electric vehicles are becoming more and more popular among households. More and more private charging stations are being installed at residential and commercial properties. Each charging station comes with a charging plug, which connects to an electric vehicle in order to transfer electricity from the station to the vehicle's battery.

This particular device works with the J1772 standard electrical plug. To provide some background, the J1772 standard electrical plug (FIG. 1) consists of a circular shape plug (1) and a locking hook at the top (3). The plug itself can be connected to a vehicle with a battery that requires charging from such stations. For electric vehicles that adapt to this standard, there will be a receiving circular port (2) with a notch (4) on top. A button can be pressed on the plug (5) that lifts the locking hook (3) over the notch (4). Once the locking hook (3) passes behind the notch (4), the button can then be released, securing the plug onto the vehicle while it is being recharged.

When the electrical plug is not in use, usually it gets stored in a holster or just simply left hanging on the wall. However, anyone can walk up and remove the electrical plug from the holster and attach the electrical plug onto their own vehicles. Currently there is a lack of a simple, after-market accessory to prevent unauthorized use of such facilities. Anyone can drive up to a parking lot adjacent or close to a charging station and remove the plug. This invention is simple, requires no external power source, and allows the charging plug to be locked with a padlock, preventing unauthorized users from using the charging stations.

### SUMMARY OF THE INVENTION

The main purpose of this is to prevent unauthorized use of electrical charging stations by disallowing the charging plug from connecting to an unauthorized electric vehicle. It pertains to a component that can be secured on an existing J1772 electrical plug at private charging stations.

The main component consists of an outer shell and an inner shell. A sub-component includes a spacer within the outer shell which can be inserted to accommodate smaller plugs. The inner shell can be slided freely along the side tracks of the outer shell. When the device is in the opened position, an opening space will be exposed and the electrical plug can slide fully onto the notch of the inner shell. When the user slides the outer shell over the inner shell into the close position, the outer shell will then slide over the locking hook of the J1772 plug, preventing it from being removed from the plug lock. A user will then install a padlock or key lock at the end of the device to prevent the outer shell from sliding back into the open position.

### DESCRIPTION OF THE SEVERAL VIEWS OF THE DRAWING

FIG. 1 is a prior art demonstrating how the existing J1772 standards charging facility works, with an electric plug and a charging port on an electric vehicle

FIG. 2 is the front view of the invention, showing the outer enclosure and the front lock anchor

FIG. 3 is a front-side elevational view of the present invention in the close position, showing the front lock anchor of the inner shell passing through the opening of the outer shell. It also shows how the inner shell can move along the tracks of the outer shell

FIG. 4 is a front-side elevational view of the present invention in the open position, showing the front lock anchor of the inner shell retracting into the outer shell. It also shows how the inner shell will not be able to slide or retract if there is a lock on the lock anchor.

FIG. 5 is a side elevational view of the present invention in the open position, showing the enclosure moving away from the notch, generating an open space and ready to receive the electrical plug.

FIG. 6 is the side elevational view of the present invention in the close position, showing how the outer enclosure covers the notch.

FIG. 7 is the side view of the present invention in the open position, showing the electrical plug's locking latch being lifted and about to go over the said invention's notch.

FIG. 8 is the side view of the present invention in the open position, showing the electrical plug's locking latch crossing over the said invention's notch.

FIG. 9 is the side view of the present invention in the open position, showing the electrical plug's locking latch catching the notch when its button is released.

FIG. 10 is the side view of the present invention in the close position, with a see-through illustration of the outer shell covering the locking hook of the electrical plug, and in turn securing the electrical plug in place

FIG. 11 is the side view of the present invention in the close position, with a padlock being installed over the lock anchor of the inner shell, preventing it from being retracted away from the outer shell.

FIG. 12 is the top elevational view showing the optional spacer, which allows electrical plugs with smaller locking latch to be used.

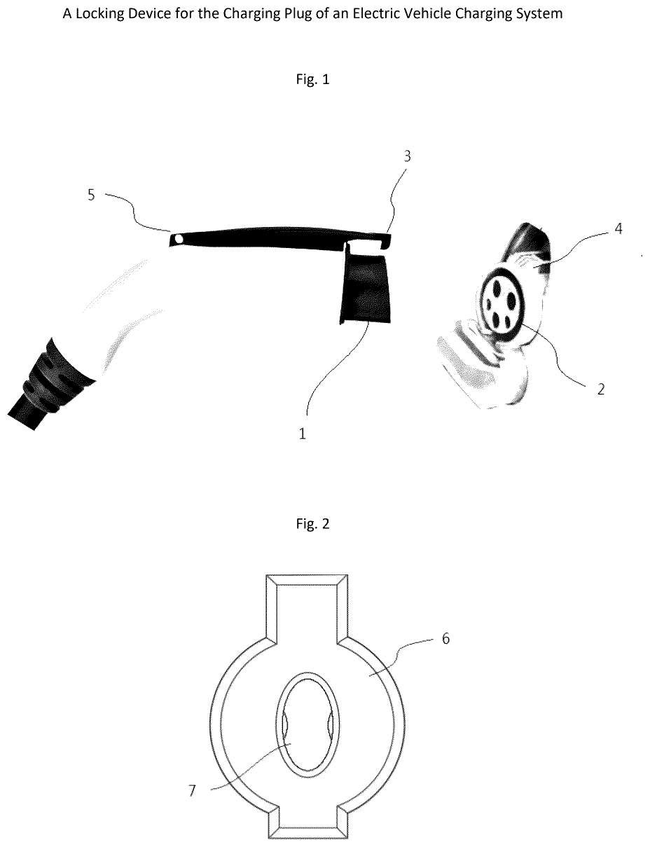

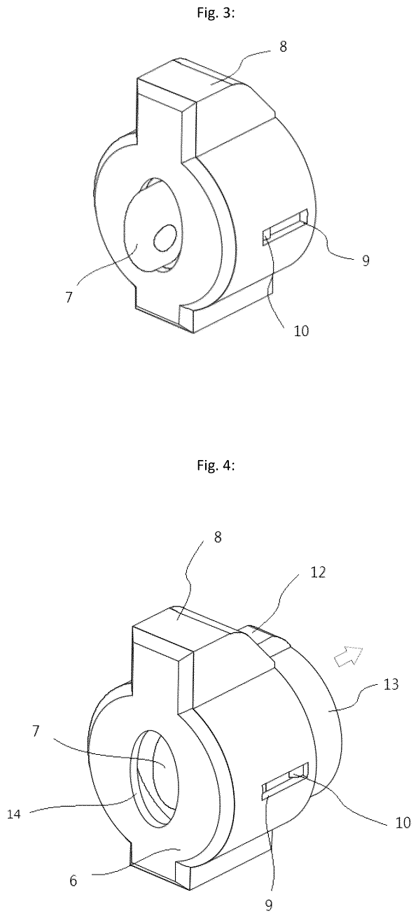

### DETAILED DESCRIPTION OF THE INVENTION

Although the invention will be described in connection with certain preferred representations, it will be understood that the invention is not limited to those particular representations. The invention is intended to cover all alternatives, modifications, and equivalent arrangements as may be included within the spirit and scope of the invention as defined by the items listed under Claims.

An electrical plug locking device is described. FIG. 1 illustrates an example of an existing charging station of prior art, which normally consists of a charging plug that is connected to a charging station via an electric cord. The electric plug itself can be removed from a charging station and connected to an electric vehicle for charging the vehicle's battery. Several standards of charging plug exist, and this invention is specifically designed for the J1772 standards. This charging plug type has a circular shape (#1) that can be inserted into a similar port (#2) located on a charging vehicle. The way the charging plug is secured onto the charging vehicle is by the means of a locking hook (#3). All vehicles adapting to this standards will have a notch (#4) on top of the charging port. When a button (#5) is pressed on the electrical plug, the locking hook (#3) is lifted and can be cleared over the notch (#4) while the plug is being inserted into the port. Once the locking hook passes over the notch, the button on the electrical plug can then be released, and the hook is now behind the notch, preventing the plug from falling off of the vehicle while the battery is being recharged.

This invention is designed to provide a locking enclosure for the charging plug (#1), ensuring the hook (#3) cannot be disengaged from the latch (#4) unintentionally or without authorization. With reference to the drawings, one embodiment of the invention mainly consists of an outer shell, an inner shell and a removable spacer that allows the invention to accommodate slightly smaller electrical plugs. The circular outer shell (#7) can slide in and out of the inner shell (#13). The locking device therefore has two positions. When the outer shell is slided away from the inner shell, it is in the open position; when the outer shell is slided toward the inner shell, it is in the close position.

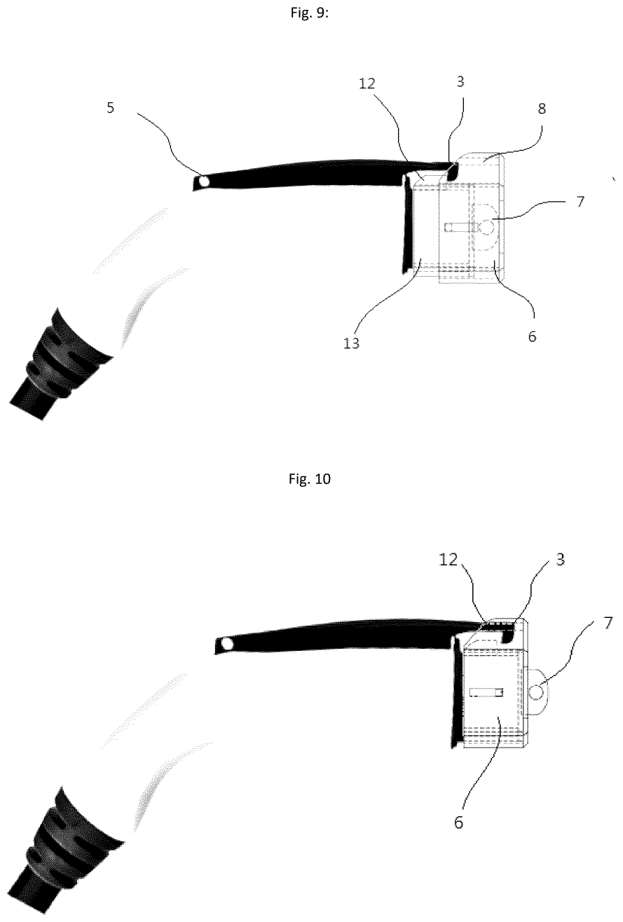

To build the device, the inner shell (#13) can be started off being described as a cylindrical shape. One end is opened and is made the same shape as the charging plug using the J1772 standard, which is circular by design. This inner shell is made slightly larger than the plug so that the charging plug can be inserted into it. The inner shell has a notch on top (#12 in Drawings), allowing the locking hook of a J1772 charging plug to be hooked onto (#3). All J1772 plug has a locking hook that can be pivoted via a button (#5). Like a ‘toggling switch’, the locking hook (#3 in Drawings) can be raised above this notch (#12) when the button is pressed, and sit over the notch when the button is released. (FIG. 9)

The inner shell has two small notches on the side (#10). These can be used for sliding along tracks on the outer shell (#9) and allow the inner shell to be moved freely relative to the outer shell.

At the other end of the inner shell where it is not receiving the electrical plug, a lock anchor is provided so that a padlock can be installed (#7). This lock anchor passes through an opening (#14) on the outer shell as the inner shell moves in relation to the outer shell.

The outer shell is also cylindrical in shape to start with and wraps around the inner shell. On one end, it is opened as well for receiving the electrical plug. On the other end, it has a small opening (#14) that allows the said lock anchor (#7) of the inner shell to pass through. On the top of the outer shell, it has an additional enclosure (#8) that is fixated over the top of the shell, where it will cover the locking hook once the charging plug is inserted into the device. The outer shell slides around the inner shell via two small tracks on the side (#9) over the notches of the inner shell previously mentioned (#10).

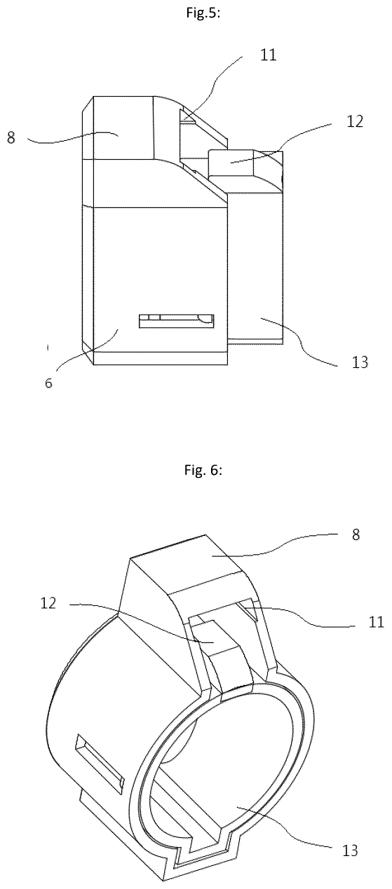

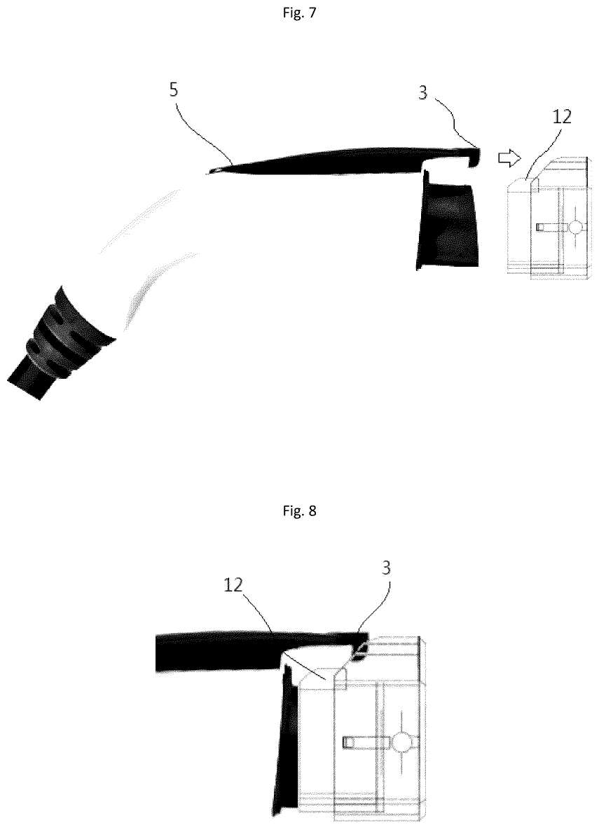

In order to receive the charging plug, the locking device will need to be in the open position first (FIG. 7). This allows the enclosure (#8) to slide away from the notch (#12). This generates an open space (FIG. 5) and allows the electrical plug be inserted into the inner shell while the locking hook (#3) is raised by pressing the button on the electrical plug (#5). When the hook is lifted, it will be cleared over the notch (#12) and allow the electrical plug to be fully inserted into the inner shell (FIG. 8).

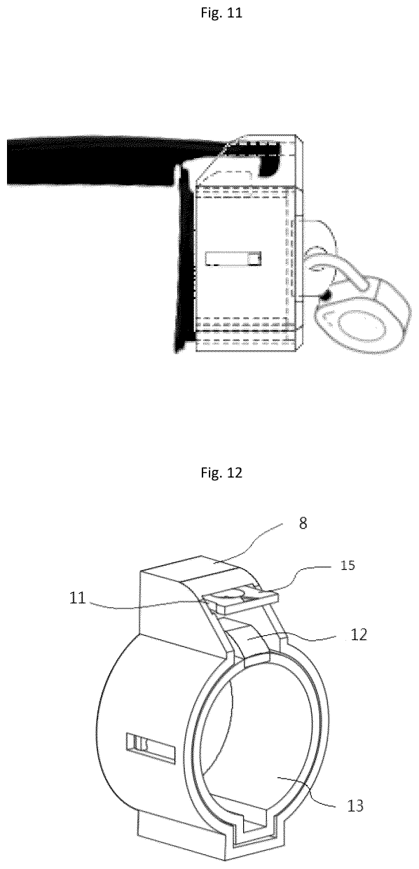

Once the locking hook is cleared over the notch, the button on the electrical plug (#5) can be released and the locking hook will be secured onto the notch (FIG. 9). Next, the outer shell can be slided over the inner shell in the direction of the electrical plug. This in turn will slide the enclosure on the outer shell (#8) over the locking hook; the locking hook will no longer be able to be lifted over the notch and henceforth released from the plug lock (FIG. 10). Through the same motion above, the locking anchor of the inner shell (#7) will pass through the openings on the outer shell (#14). The entire device will then be secured by a padlock or key lock that gets installed on the lock anchor (FIG. 11). Since this anchor is attached to the inner shell and is exposed through an opening on the outer shell (#7), having a padlock on this anchor will prevent the outer shell from sliding back into the open position. The charging plug is now secured and no one will be able to use the charging plug on an electric vehicle.

A small spacer (#15) can be inserted into specially designed railings (#11) on the outer shell in the enclosure area (#8). When certain electrical plug is being used, its locking hook might be too small and the enclosure (#8) can still generate too much opening space, allowing the locking hook to be lifted and cleared from the notch, permitting the electrical plug to be removed from the inner shell. Having a spacer will reduce this opening space and prevent this from happening.

In order to remove the electrical plug from the plug lock, the padlock or key lock needs to be removed from the lock anchor first (#7). This allows the lock anchor to slide through the outer shell's opening (#14) and enable the device to be in its Open position again. When this is being done, the outer shell enclosure (#8) will in turn slide away from the notch (#12) in the other direction, generating an opening space over the locking hook once again (FIG. 5). In turn, the locking hook on the electrical plug can now be lifted away from the notch (FIG. 8) and the electrical plug can now be removed from the inner shell.

Although the embodiments of the present invention have been described in detail above, the present disclosure is used to help the overall understanding of the invention and is not limited to the above-described embodiments, and various design changes can be made without departmenting from the spirit of the present disclosure described in the claims.

1. The electric vehicle charging plug lock is a standalone device that comprises of:
an inner shell in the shape of a J1772-standard electrical plug;
an outer shell that slides around the said inner shell; and
a spacer which can be optionally inserted into the said outer shell.

2. The locking device of claim 1 of the said inner shell further comprises a notch that allows the locking hook of an electrical plug to be abut onto.

3. The locking device of claim 1 of the said inner shell can slide into the said outer shell through designed tracks into a close position, or slide away from the said outer shell into an open position.

4. The locking device of claim 1 of the said Inner shell contains a locking anchor which passes through an opening of the said outer shell, allowing a lock to be installed and preventing the said inner shell from sliding away from the said outer shell.

5. The locking device of the said outer shell further comprises an enclosure that can shield over the notch on the said inner shell according to claim 2, preventing the locking hook of an electrical plug from disengaging from the said notch on the inner shell.

6. The enclosure of claim 5 of the said outer shell can be slide away from the notch in relative to the position of the said inner shell, allowing the electrical plug locking hook to be released.

7. The locking device of claim 5 of the said enclosure has a slot which allows a spacer to be inserted into, further restricting the space within the said enclosure for electrical plugs with smaller locking hooks.
